(19) United States
(12) Patent Application Publication
(10) Pub. No.: US 2019/0360519 A1
(43) Pub. Date: Nov. 28, 2019

(54) BICYCLE CABLE AND SYSTEM HAVING THE SAME

(71) Applicant: Yuan-Hung WEN, Chang Hua County (TW)

(72) Inventor: Yuan-Hung WEN, Chang Hua County (TW)

(21) Appl. No.: 16/438,111

(22) Filed: Jun. 11, 2019

Related U.S. Application Data
(63) Continuation-in-part of application No. 15/938,943, filed on Mar. 28, 2018.

(30) Foreign Application Priority Data
Apr. 13, 2017 (TW) 106112308

(51) Int. Cl. F16C 1/20; F16C 1/26; B60T 11/04

(52) U.S. Cl. CPC F16C 1/20; F16C 1/26; B60T 11/046; F16C 2326/20; F16C 2240/46; F16C 2240/70; D07B 2201/2027

(57) ABSTRACT

A bicycle cable includes an inner line and an outer sheath. The inner line connects a driving mechanism and a driven device of a vehicle therebetween. The driven device includes a brake device or a derailleur. The inner line is composed of a plurality of threads twining together. The inner line has a maximum outer diameter ranged of 1.2 mm, and a minimum outer diameter ranged between 0.90-1.0 mm. The outer sheath has an outer diameter ranged between 3.5-4.5 mm and an inner diameter ranged between 2.0-2.2 mm. The outer sheath is sleeved onto the inner line. A gap formed between an inner face of the outer sheath and the inner line has a maximum ranged between 0.8 mm to 1.3 mm.

### CROSS REFERENCE TO RELATED APPLICATIONS

This application is a Continuation-in-Part of co-pending application Ser. No. 15/938,943, filed on Mar. 28, 2018, for which priority is claimed under 35 U.S.C. § 120; and this application claims priority of Application No. 106112308 filed in Taiwan on Apr. 13, 2017 under 35 U.S.C. § 119, the entire contents of all of which are hereby incorporated by reference.

### BACKGROUND OF THE INVENTION

### Field of the Invention

The present invention relates to a bicycle cable and a system having the bicycle cable.

### Description of the Prior Art

A conventional bicycle cable for braking or derailleur is composed of a plurality of threads, and a sheath is sleeved onto the threads. The threads triggers the brake device or derailleur to operate when driven by grip of brake or derailleur.

Generally, the inner line of brake cable has a bigger diameter to meet the need of quick transmission and bigger force. Thus, the diameter of the inner line is usually equal to or larger than 1.5 mm. In addition, the sheath of brake cable also has a bigger inner diameter and a bigger outer diameter so that the sheath is difficult to bend and install. Besides, the maximum gap between the sheath and the inner line is about 1.0 mm so that the force cannot be transmitted directly to reduce the performance of braking. On the contrary, the need of transmission to derailleur is lower than that to brake cable, so the inner line of derailleur cable usually has a smaller diameter. Of course, the sheath has smaller inner diameter and outer diameter, and the gap between the sheath and the inner line is smaller too.

Thus, two kinds of cables in different sizes have to be used in a bicycle. Cost is high, and installation is difficult.

For example, the cable of US 2006/0240702 has a extremely small gap between the inner line and the sheath. The cable of US 2011/0100151 further pointed out that the gap is preferably 1.0 mm or less. Besides, the inner line of the cable of EP 982505 has a small diameter ranged between 0.6-0.8 mm to be impossible to meet the CNS (Chinese National Standards) and the CPSC (Consumer Product Safety Commission).

### SUMMARY OF THE INVENTION

The main object of the present invention is to provide a bicycle cable and a system of bicycle cable which are applicable to both brake system and derailleur system.

To achieve the above and other objects, a bicycle cable of the present invention includes an inner line and an outer sheath. The inner line connects a driving mechanism and a driven device of a vehicle therebetween. The driven device includes a brake device or a derailleur. The inner line is composed of a plurality of threads twining together. The inner line has a maximum outer diameter of 1.2 mm. The inner line has a minimum outer diameter ranged between 0.90 mm to 1.0 mm. The outer sheath has an outer diameter ranged between 3.5 mm to 4.5 mm and an inner diameter ranged between 2.0 mm to 2.2 mm. The outer sheath is sleeved onto the inner line. A gap is formed between an inner face of the outer sheath and the inner line. The gap has a maximum ranged between 0.8 mm to 1.3 mm.

To achieve the above and other objects, a system of bicycle cable of the present invention includes two bicycle cables mentioned above. One of the inner lines connects a brake driving mechanism and a brake device therebetween. The other one of the inner lines connects a derailleur driving mechanism and a derailleur therebetween.

The present invention will become more obvious from the following description when taken in connection with the accompanying drawings, which show, for purpose of illustrations only, the preferred embodiment(s) in accordance with the present invention.

### BRIEF DESCRIPTION OF THE DRAWINGS

FIG. 1 is a stereogram of the present invention;

FIG. 2 is a profile of FIG. 1;

FIG. 3 is an illustration of the present invention;

FIG. 4 is a partial enlargement of the present invention;

FIG. 5 is a graph showing a relationship between a gap and a tension of the present invention;

FIG. 6 is a graph showing a relationship between a gap and a grip force of the present invention.

### DETAILED DESCRIPTION OF THE PREFERRED EMBODIMENTS

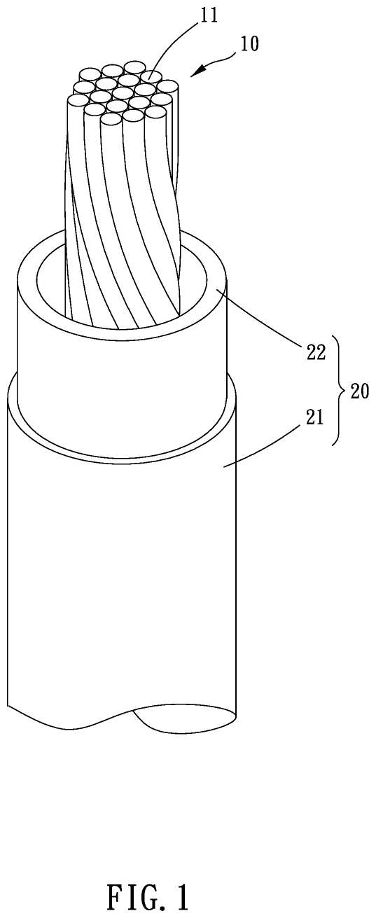

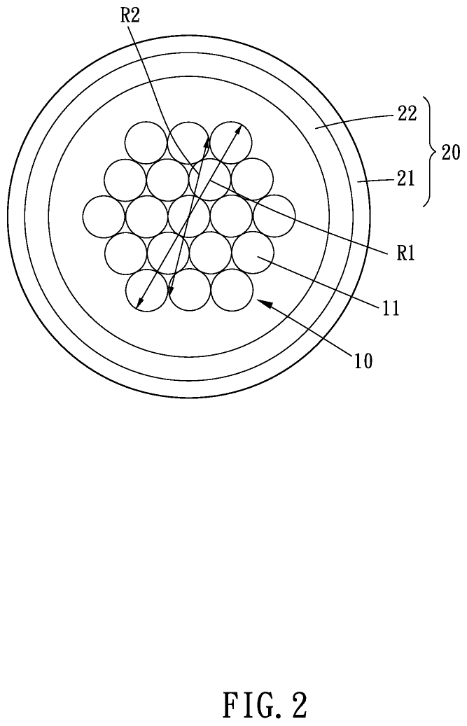

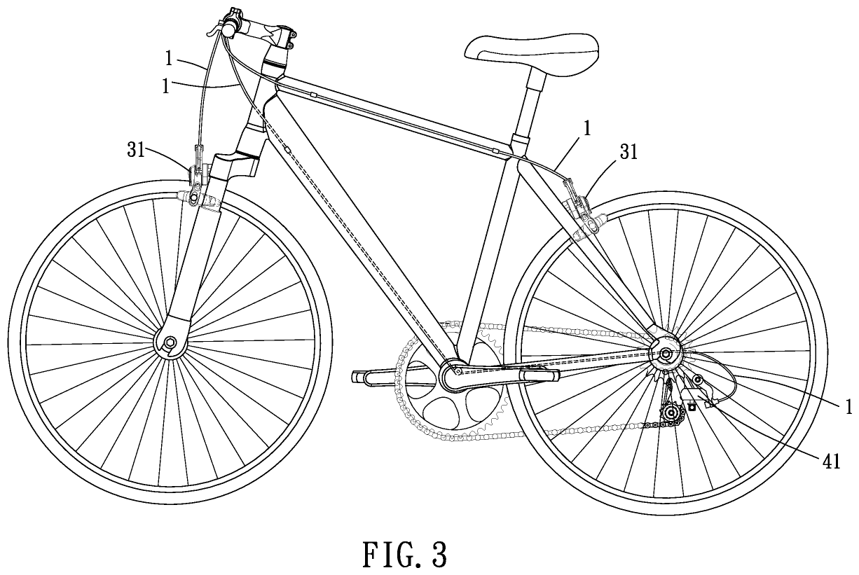

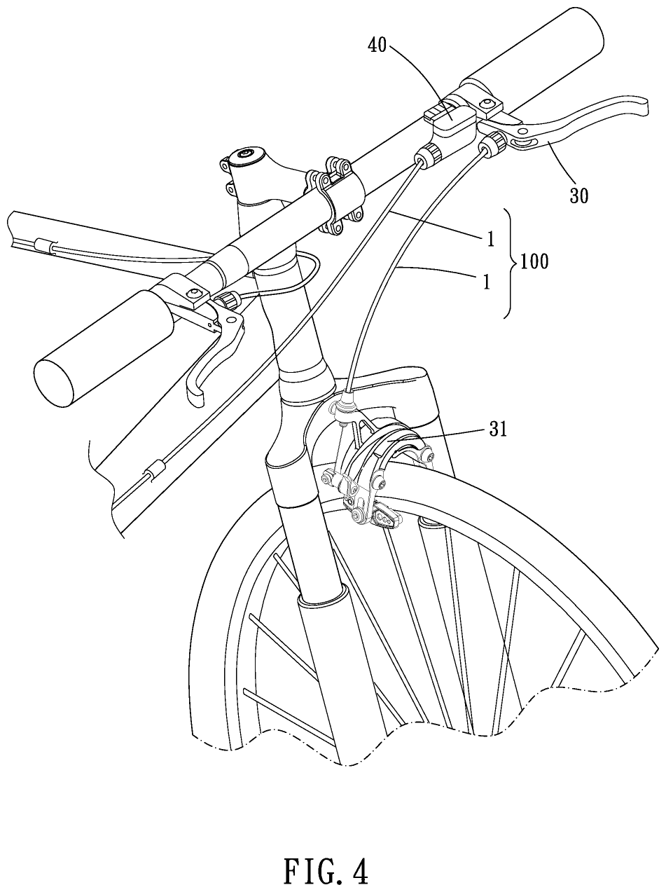

Please refer to FIGS. 1-4, the bicycle cable 1 of the present invention includes an inner line 10 and an outer sheath 20.

The inner line 10 connects a driving mechanism and a driven device of a vehicle therebetween. The driving mechanism includes brake driving mechanism 30 or derailleur driving mechanism 40. The driven device includes brake device 31 or derailleur 41. The inner line 10 is composed of a plurality of threads twining together. In the present embodiment, the inner line is composed of 19 threads arranged at 1, 6, and 12 threads per layer from the center outward. The inner line 10 has a maximum outer diameter D1 ranged of 1.2 mm. The inner line 10 has a minimum outer diameter D2 ranged between 0.90 mm to 1.0 mm. In the present embodiment, the inner line is composed of the 19 threads, so the contour of cross-section of the inner line is not a circle. The maximum outer diameter D1 is about the sum of five times the diameter of one thread, and the minimum outer diameter D2 is defined as the distance between recessed portions at two ends along the radial direction. The outer sheath 20 has an outer diameter ranged between 3.5 mm to 4.5 mm and an inner diameter ranged between 2.0 mm to 2.2 mm. The outer sheath 20 is sleeved onto the inner line 10. A gap 50 is formed between an inner surface of the outer sheath 20 and the inner line 10. The gap 50 has a maximum (when an opposite side of the inner line abuts against the inner surface of the outer sheath) ranged between 0.8 mm to 1.3 mm Thereby, the bicycle cable 1 can be used in brake system or derailleur system.

The outer sheath 20 includes an inner layer 22 and an outer layer 21 sleeved onto the inner layer 22.

Please refer to FIGS. 1-3, the outer diameter of the inner line 10 is preferably 1.4 mm, and the inner diameter of the outer sheath 20 is preferably 2.0 mm. However, the diameters of the inner line and the outer sheath can be alternated according to the needs, such as the diameter of wheel, the weight of bicycle, different brake devices, different derailleurs, different conditions of use. Specifically, the inner line 10 of the present invention has a smaller diameter than conventional ones (1.5 mm), and the gap between the inner line 10 and the outer sheath 20 of the present invention is smaller than those of conventional bicycle cables. Thus, transmission during braking or derailleur becomes director and more precise.

The present invention also provides a bicycle cable system 100 includes two said bicycle cables 1. The inner line 10 of one of the bicycle cables 1 connects a brake driving mechanism 30 and a brake device 31 therebetween, and the inner line 10 of the other one of the bicycle cables 1 connects a derailleur driving mechanism 40 and a derailleur 41 therebetween. The gaps 50 of the two bicycle cable 1 are equal. The inner lines 10 of the two bicycle cables 1 have the same structure and are made of the same material. The outer sheaths 20 of the two bicycle cables 1 also have the same structure and are made of the same material.

In view of the practical data:

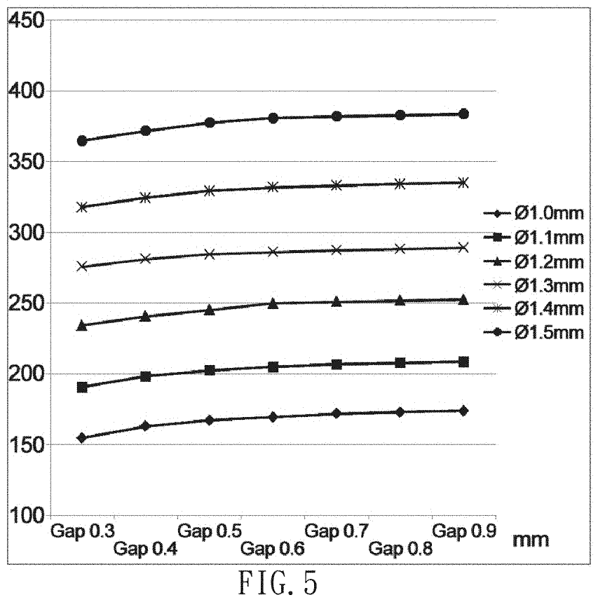

1. As ruled in the CNS (Chinese National Standards), the tension of the bicycle cable must be equal to or larger than 240 kg. As shown in the following table and FIG. 5, the outer diameter of the inner line must be equal to or larger than 1.2 mm to give a tension larger than 240 kg (bold-faced) to meet the rules of CNS.

| | Gap | Gap | Gap | Gap | Gap | Gap | Gap |
|---|---|---|---|---|---|---|---|
| Tension | 0.3 | 0.4 | 0.5 | 0.6 | 0.7 | 0.8 | 0.9 |
| (kg) | mm | mm | mm | mm | mm | mm | mm |
| Φ1.0 mm | 154.6 | 162.9 | 167.2 | 169.3 | 171.8 | 172.9 | 173.7 |
| Φ1.1 mm | 190.7 | 198.1 | 202.4 | 204.8 | 206.6 | 207.7 | 208.4 |
| Φ1.2 mm | 234.1 | 240.6 | 245.1 | 249.7 | 250.8 | 251.7 | 252.5 |
| Φ1.3 mm | 275.7 | 281.1 | 284.3 | 286.0 | 287.2 | 288.1 | 289.0 |
| Φ1.4 mm | 317.8 | 324.4 | 329.3 | 331.7 | 333.1 | 334.2 | 335.1 |
| Φ1.5 mm | 364.7 | 371.6 | 377.5 | 380.8 | 381.9 | 382.8 | 383.6 |

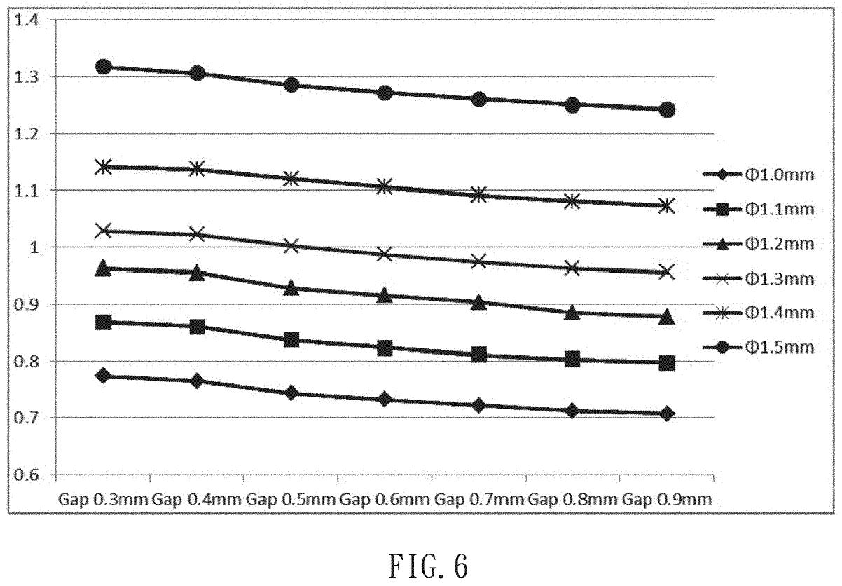

2. As ruled by CPSC (Consumer Product Safety Commission), the grip force must be equal to or smaller than 4.51b (2.045 kg). As shown in the following table and FIG. 6, the grip force of the conventional 1.5 mm brake cables are smaller than 2.045 kg as ruled, but larger than 1.5 kg to be 3-4 times the force of brake handle of hydraulic brake (0.536 kg). Thus, the cable cannot provide a handle similar to the hydraulic brake. However, the handle of hydraulic brake is preferable for bicycle industry and users. Conventional brake cables (1.5 mm) are unable to make it.

| | Front brake | Rear brake |
|---|---|---|
| SHIMANO hydraulic disk | 0.536 kg | 0.468 kg |
| brake | | |
| BIANCHI road bike | 1.700 kg | 1.640 kg |
| Infinity road bike | 1.992 kg | 1.941 kg |
| Bicycle for kids | 1.508 kg (New type) | 3.912 kg (Old type) |

| | Gap | Gap | Gap | Gap | Gap | Gap | Gap |
|---|---|---|---|---|---|---|---|
| Grip force | 0.3 | 0.4 | 0.5 | 0.6 | 0.7 | 0.8 | 0.9 |
| (kg) | mm | mm | mm | mm | mm | mm | mm |
| Φ1.0 mm | 0.774 | 0.765 | 0.743 | 0.732 | 0.721 | 0.712 | 0.707 |
| Φ1.1 mm | 0.868 | 0.86 | 0.837 | 0.823 | 0.811 | 0.803 | 0.797 |
| Φ1.2 mm | 0.963 | 0.955 | 0.929 | 0.916 | 0.904 | 0.885 | 0.878 |
| Φ1.3 mm | 1.029 | 1.022 | 1.002 | 0.987 | 0.974 | 0.963 | 0.956 |
| Φ1.4 mm | 1.141 | 1.137 | 1.12 | 1.106 | 1.092 | 1.081 | 1.073 |
| Φ1.5 mm | 1.318 | 1.306 | 1.285 | 1.272 | 1.26 | 1.251 | 1.243 |

Therefore, when the outer diameter of the inner line is ranged between 1.2 mm to 1.4 mm and the maximum of the gap is 0.8 mm, the tension is larger than 240 kg to meet the standard of CNS, and the handle is similar to hydraulic brake (bolt-faced in the previous table). That is, the handle similar to hydraulic brake is provided by the appropriate combination of the outer diameter of the inner line and the gap in the present invention, and it's applicable for both brake cable and derailleur cable.

In conclusion, the bicycle cable and the system of the bicycle cable can be used in both brake system and derailleur system, so it's not necessary to have brake cable and derailleur cable which are different from each other. Thus, it's easy and quicker for installation. Besides, the size of the inner line can provide sufficient braking force. In addition, the appropriate gap makes installation easier and smoother, and the friction between the inner line and the outer sheath is reduced. Also, the transmission becomes direct and precise.

1. A bicycle cable, including:
an inner line, connecting a driving mechanism and a driven device of a vehicle therebetween, the driven device including a brake device or a derailleur, the inner line being composed of a plurality of threads twining together, the inner line having a maximum outer diameter of 1.2 mm, the inner line having a minimum outer diameter ranged between 0.90 mm to 1.0 mm;
an outer sheath, having an outer diameter ranged between 3.5 mm to 4.5 mm and an inner diameter ranged between 2.0 mm to 2.2 mm, sleeved onto the inner line, a gap being formed between an inner face of the outer sheath and the inner line, the gap having a maximum ranged between 0.8 mm to 1.3 mm.

2. The bicycle cable of claim 1, wherein the outer sheath includes an inner layer and an outer layer sleeved onto the inner layer, the inner layer includes a plurality of threads extending along a longitudinal direction of the inner line and arranged around the inner line.

3. The bicycle cable of claim 2, wherein the threads twist around the inner line.

4. The bicycle cable of claim 1, wherein the threads are metal threads or reinforced fiber, the reinforced fiber is selected from a group composing of carbon fiber, graphite fiber, fiberglass, and Kevlar.

5. The bicycle cable of claim 1, wherein the outer sheath includes an inner layer and an outer layer sleeved onto the inner layer, the inner layer includes a continuous spiral sheath which is composed of a single thread twists around the inner line continuously.

6. A system of bicycle cable, including two bicycle cables of claim 1, wherein one of the inner lines connects a brake driving mechanism and a brake device therebetween, the other one of the inner lines connects a derailleur driving mechanism and a derailleur therebetween.

7. The system of bicycle cable of claim 6, wherein the inner lines have a same size, the outer sheaths have a same size.

8. The system of bicycle cable of claim 6, wherein the gaps of the two bicycle cables are equal.

9. The system of bicycle cable of claim 6, wherein the two inner lines have a same structure and are made of a same material, the two outer sheaths have a same structure and are made of a same material.
